(19) United States
(12) Patent Application Publication
(10) Pub. No.: US 2003/0007203 A1
(43) Pub. Date: Jan. 9, 2003

(54) IR lens from moldable infrared material

(76) Inventors: Max Amon, Maitland, FL (US); James A. Carter, Indialantic, FL (US)

Correspondence Address: Patrick C. Keane, BURNS, DOANE, SWECKER & MATHIS, L.L.P., P.O. Box 1404, Alexandria, VA, 22313-1404, US

(21) Appl. No.: 09/832,833

(22) Filed: Apr. 12, 2001

(51) Int. Cl. G02B 5/32; G02B 13/14

(52) U.S. Cl. 359/19; 359/355

(57) ABSTRACT

An infrared lens is made from a moldable IR transmissive material and has an optically significant surface with a surface relief holographic grating. The moldable IR transmissive material is an arsenic selenide glass. The lens and the optically significant surface are manufactured as a unitary structure in a molding operation.

### BACKGROUND

### FIELD OF THE INVENTION

The present device is directed generally to infrared (IR) optical systems. More specifically, the present invention is directed to an IR lens made from a moldable IR transmissive material. The IR lens can have an optically significant surface formed directly in the molding process.

### BACKGROUND INFORMATION

Infrared electromagnetic radiation refers to the region of the electromagnetic spectrum between wavelengths of approximately 0.7 and 1000 μm, which is between the upper limit of the visible radiation region and the lower limit of the microwave region. Infrared radiation is sometimes broken into three sub-regions: near-infrared radiation with wavelengths between 0.7-1 μm, intermediate-infrared radiation with wavelengths between 1-20 μm, and far-infrared radiation with wavelengths between 20-1000 ,μm. The intermediate-infrared radiation region is often further broken into the short-wave (SWIR) region with wavelength limits of 1-3 μm, mid-wave (MWIR) region with wavelength limits of 3-5 μm, and the long-wave (LWIR) region with wavelength limits of 8-14 μm.

Infrared radiation is produced principally by electromagnetic emissions from solid materials as a result of thermal excitation. The detection of the presence, distribution, and direction of infrared radiation requires techniques which are unique to this spectral region. The wavelengths of infrared radiation are such that optical methods may be used to collect, filter, and direct the infrared radiation. Photosensitive devices convert heat, or infrared electromagnetic radiation, into electrical energy and are often used as infrared sensitive elements. Such photosensitive devices respond in proportion to the number of infrared photons within a certain range of wavelengths to provide electrical energy.

An infrared lens is transmissive to the wavelengths of radiation to be detected. Materials for a lens are wavelength matched to the desired spectrum coverage. Although suitable materials may be selected based on the range of IR wavelengths, other material characteristics can impact the manufacturing of IR lenses. For example, the optical characteristics of silicon are advantageous for use as the material for IR lenses. Silicon can be cut into the desired lens geometry, using, for example, a diamond tool to manufacture the surface. However, the hardness of silicon results in slow material removal and wears the diamond tool faster than other IR materials like germanium. In extreme cases, the cost of manufacturing silicon into IR lenses can negate the cost savings from the bulk material and cause optical materials used in the IR spectral range to be expensive and require expensive manufacturing processes. Therefore, material and manufacturing processes for IR lenses that are inexpensive and quick are desirable.

### SUMMARY OF THE INVENTION

Exemplary embodiments of the present invention are directed to providing an IR lens made from moldable IR transmissive material. The IR lens has at least one optically significant surface formed directly in a molding process.

In accordance with exemplary embodiments, an IR lens has a first surface and a second surface, is a moldable IR transmissive material, and at least the second surface is an optically significant surface. The optically significant surface can be formed directly in a molding operation and can be a nonspherical surface comprising a surface relief holographic grating. Moldable IR transmissive materials are chalcogenide glasses, with exemplary chalcogenide glasses including arsenic selenide glass, a non-oxide chalcogenide glass.

A method of forming an IR lens heats a moldable IR transmissive material, such as arsenic selenide glass, above the glass transition temperature, molds the moldable IR transmissive material into a shape for an IR lens with at least one optically significant surface and cools the moldable IR transmissive material to below the glass transition temperature. In exemplary methods, the optically significant surface is spherical or non-spherical and can have a surface relief holographic grating. The IR lens can be coated with an optical surface coating.

### BRIEF DESCRIPTION OF THE DRAWING FIGURES

Other objects and advantages of the invention will become apparent from the following detailed description of preferred embodiments in connection with the accompanying drawings in which like numerals designate like elements and in which:

FIG. 1 is a schematic representation of the line trace of energy in a first embodiment of the optical components of an IR optical system utilizing an IR lens made from moldable IR transmissive material;

FIG. 2 is an embodiment of an IR lens made from moldable IR transmissive material; and

FIG. 3 is another embodiment of an IR lens made from moldable IR transmissive material.

### DETAILED DESCRIPTION OF THE PREFERRED EMBODIMENTS

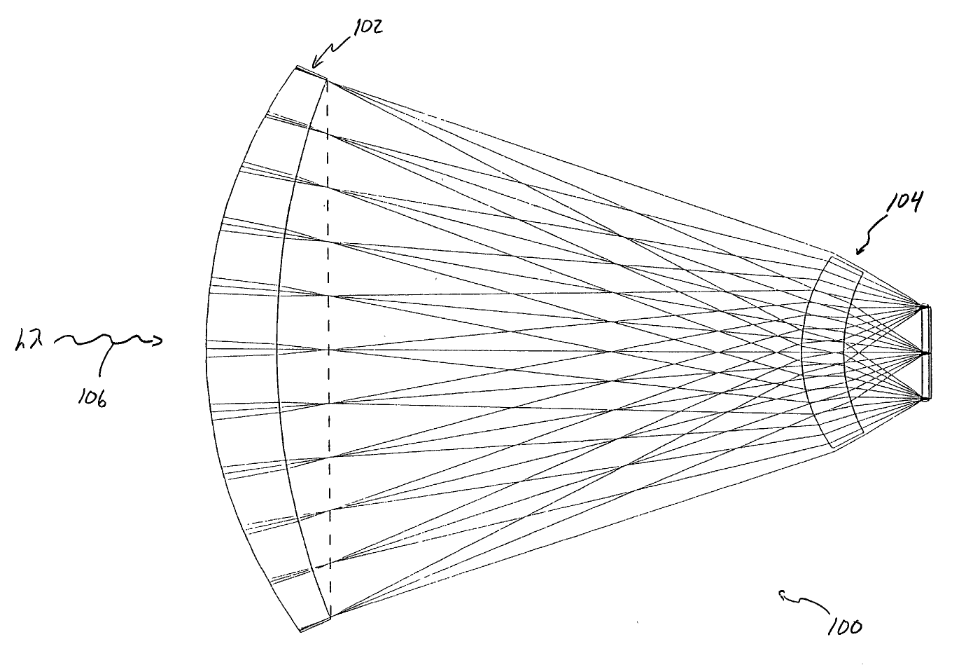

FIG. 1 shows an exemplary embodiment of an optical arrangement 100 with a first IR lens 102 and a second IR lens 104. The first IR lens 102 and the second lens 104 are made from a moldable IR transmissive material. Incident IR energy 106 is transmitted by and shaped into a wavefront of energy by the elements of the optical arrangement 100, ultimately transmitting the incident energy 106 to recreate an image at the focal distance of the optical arrangement.

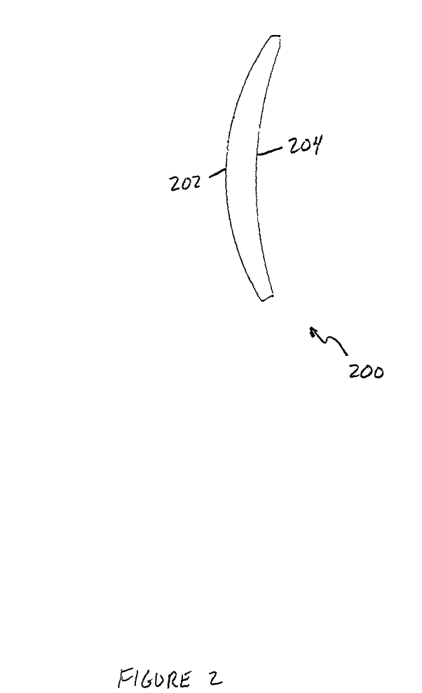

FIG. 2 is an embodiment of an IR lens 200 made from a moldable IR transmissive material with a first surface 202 and a second surface 204. At least one of the surfaces of the IR lens 200 is an optically significant surface. In the exemplary embodiment shown, the first surface 202 has a spherical radius R₁ and a second surface 204 is aspheric with a surface relief holographic grating (kinoform) for a desired constructive wavelength. As used herein, optically significant surface is any surface profile that transmits a desired wavelength of energy and shapes the wavefront of energy. Examples of optically significant surfaces include flat, spherical, aspherical, and kinoform surfaces. The kinoform has thirteen rotationally symmetric concentric zones. Within each zone, the surface SAG Z(Y) varies with radial coordinate Y according to Equation 1.

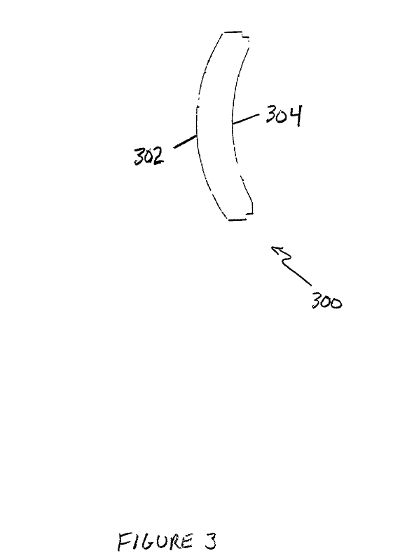

FIG. 3 is another embodiment of an IR lens 300 made from a moldable IR transmissive material with a first surface 302 and a second surface 304 . At least one of the surfaces of the IR lens 300 is an optically significant surface. In the exemplary embodiment shown, the first surface 302 has a spherical radius R₁ and a second surface 304 is aspheric with a surface relief holographic grating (kinoform) for a desired constructive wavelength. The kinoform has five rotationally symmetric concentric zones. Within each zone, the surface SAG Z(Y) varies with radial coordinate Y according to Equation 1.

Equation 1 mathematically defines an aspherical surface with a kinoform:

$$Z ( Y ) = \frac{{CY}^{2}}{1 + \sqrt{1 - {C}^{2} ( k + 1 ) {Y}^{2}}} + {DY}^{4} + {EY}^{6} + {FY}^{8} + {GY}^{10} + \frac{( λ {L}_{i} - ( {H}_{2} {Y}^{2} + {H}_{4} {Y}^{4} + {H}_{6} {Y}^{6} + {H}_{8} {Y}^{8} + {H}_{10} {Y}^{10} ) )}{( {N}_{λ} - 1 )} \qquad Eq . 1$$

where C=1/R, R=radius of curvature, k=conic coefficient, D, E, F, and Y are aspheric coefficients, and H₂, H₄, H₆, H₈, and H₁₀ are coefficients of the kinoform.

There is a correspondence between the conic coefficient of Eq. 1 and the geometric surface profile. Table 2 illustrates this correspondence.

TABLE 2
Correspondence between k and the type of profile

| Value of k | Type of Profile |
|---|---|
| >0 | ellipse |
| = 0 | sphere |
| −1 < k < 0 | ellipse |
| = −1 | parabola |
| <−1 | hyperbola |

Table 3 includes values for the coefficients of Equation 1 for the first surfaces 204,304 of the exemplary embodiments of an IR lens 200,300 made from a moldable IR transmissive material as shown in FIGS. 2 and 3.

TABLE 3
Prescriptions of exemplary embodiments of an IR lens made
from a moldable IR transmissive material.

| | Value for FIG. 2 | Value for FIG. 3 |
|---|---|---|
| Coefficient | Embodiment | Embodiment |
| Spherical Radius | | |
| R1 | 4.013 | 1.367 |
| R2 | SAG Z(Y) | SAG Z(Y) |
| Radius of Curvature | | |
| R | 6.36153145 | 1.43446358 |
| Conic Coefficient | | |
| k | 0.00 | 0.00 |
| Aspheric Coefficients | | |
| D | 8.99073E−4 | −1.66150E−2 |
| E | −1.23621E−4 | 3.44578E−2 |
| F | 1.64831E−4 | 3.95660E−2 |
| G | −5.735059E−4 | −8.12512E−2 |
| Wavelength | | |
| λ | 10.0 μm | 10.0 μm |
| N_{λ} | 2.644067 | 2.644067 |
| Kinoform Coefficents | | |
| H2 | 8.583915296E−5 | −6.797501951E−3 |
| H4 | 8.041516347E−4 | 2.335994223E−2 |
| H6 | −2.711370989E−4 | −5.689977238E−2 |
| H8 | 3.868113843E−5 | 1.001844159E−2 |
| H10 | −1.933865193E−6 | 7.426448431E−2 |

In practice, one skilled in the art could utilize commercially available lens design software to obtain suitable values for the coefficients of Eq. 1, including the aspherical coefficients. An example of one such lens design software package is “CODE V©” available from Optical Research Associates of Pasadena, Calif. One skilled in the art could input information including, for example, image size, focal distance, energy distribution across the detector and determine the optimized values for the coefficients of Equation 1.

Examples of moldable IR transmissive materials suitable for the first IR lens 102 and second IR lens 104 include chalcogenide glasses. In the exemplary FIG. 2 and FIG. 3 embodiments, the IR lens 200,300 is formed from arsenic selenide glass, a non-oxide chalcogenide glass. Examples of suitable non-oxide chalcogenide glasses are discussed in “Non-oxide IVA VA VIA chalcogenide glasses. Part I. Glass-forming regions and variations in physical properties” by A. R. Hilton, C. E. Jones, and M. Brau, Physics and Chemistry of Glasses, vol. 7, no. 4, pages 105-126, 1966, the entire contents of which are herein incorporated by reference. Specific arsenic selenide and arsenic selenide telluride glasses are available from Amorphous Materials, Inc. of Garland, Tex. under the product name “AMTIR.” The name AMTIR is an acronym for amorphous material transmitting infrared radiation. The glass is melt formed and can be cast or slumped into most any size or shape. The material offers high optical homogeneity at low cost.

Those skilled in the art will appreciate that although the first IR lens 102 and second IR lens 104 have been described in conjunction with an arsenic selenide glass, any IR transmissive material that can be moldable can be fabricated into an IR lens using the methods of the invention.

Traditionally, an optically significant surface was formed on a lens by expensive machining processes such as computer numeric controlled diamond point turning, as known, for example, in the art of ophthalmic lens, and by grinding and polishing. However, the use of a moldable IR transmissive material for the IR lens allows for the direct manufacture of the IR lens and the respective optically significant surface in the molding process, thereby eliminating the expensive machining processes.

A method of forming an IR lens heats a moldable IR transmissive material above its glass transition temperature. The IR transmissive material is molded to form the desired IR lens shape, including the respective optically significant surface, followed by cooling to below the glass transition temperature. Examples of suitable molding techniques include slump molding, casting, and injection molding. Cooling may be by any suitable process including ambient cooling, quenching, and controlled rate cooling. The IR lens can then be coated with a surface coating for use in an IR optical system. In an exemplary process, an arsenic selenide glass is heated to a temperature from 100° C. to 200° C. and placed in a surface mold. The arsenic selenide glass forms to the mold under the force of gravity and cools to ambient temperatures, thereby forming a lens with a spherical front surface and a nonspherical surface with a surface relief holographic grating.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

What is claimed is:

1. An IR lens comprising:
a first surface; and
a second surface,
wherein the IR lens is a moldable IR transmissive material and at least one surface is an optically significant surface.

2. The IR lens of claim 1, wherein the optically significant surface comprises a surface relief holographic grating.

3. The IR lens of claim 2, wherein the optically significant surface is formed directly in a molding operation.

4. The IR lens of claim 1, wherein the moldable IR transmissive material is a chalcogenide glass.

5. The IR lens of claim 1, wherein the moldable IR transmissive material is an arsenic selenide glass.

6. The IR lens of claim 1, wherein the lens is manufactured as a unitary structure in a molding operation.

7. An IR lens comprising:
a first surface; and
a second surface,
wherein the IR lens is made from a moldable IR transmissive material and wherein at least the second surface is an optically significant surface molded from the moldable IR transmissive material.

8. A method of forming an IR lens comprising the steps of:
heating a moldable IR transmissive material above the glass transition temperature;
molding the moldable IR transmissive material into a shape for an IR lens with at least one surface that is an optically significant surface; and
cooling the moldable IR transmissive material to below the glass transition temperature.

9. The method of claim 8, further comprising the step of:
coating at least a first surface with an optical surface coating.

10. The method of claim 8, wherein molding is slump molding, casting, or injection molding.

11. The method of claim 8, wherein cooling is ambient cooling or quenching.

12. The method of claim 8, wherein the moldable IR transmissive material is an arsenic selenide glass.

13. An IR lens comprising:
a first spherical surface: and
a second nonspherical surface, wherein the second nonspherical surface comprises a surface relief holographic grating,
wherein the lens is made from a moldable IR transmissive material.

14. The IR lens of claim 13, wherein the moldable IR transmissive material is a chalcogenide glass.

15. An infrared imaging optical arrangement comprising:
a first lens; and
a second lens, wherein at least the first lens is made from a moldable IR transmissive material and wherein at least the first lens has at least one optically significant surface.

16. The infrared imaging optical arrangement of claim 15, wherein the optically significant surface comprises a surface relief holographic grating.

17. The IR lens of claim 15, wherein the moldable IR transmissive material is a chalcogenide glass.
